(19) United States
(12) Patent Application Publication
(10) Pub. No.: US 2022/0163110 A1
(43) Pub. Date: May 26, 2022

(54) Transmission Arrangement and Motor Vehicle

(71) Applicant: ZF Friedrichshafen AG, Friedrichshafen (DE)

(72) Inventors: Fabian Kutter, Kressbronn (DE); Johannes Kaltenbach, Friedrichshafen (DE); Matthias Horn, Tettnang (DE); Uwe Griesmeier, Markdorf (DE); Stefan Beck, Eriskirch (DE)

(21) Appl. No.: 17/605,684

(22) PCT Filed: Mar. 4, 2020
(86) PCT No.: PCT/EP2020/055628

§ 371 Date: Oct. 22, 2021

(30) Foreign Application Priority Data
Apr. 23, 2019 (DE) 10 2019 205 755.1

(51) Int. Cl. F16H 63/30; F16H 3/54; F16H 3/66

(52) U.S. Cl. CPC F16H 63/3013; F16H 3/54; F16H 2200/2094; F16H 2063/3093; F16H 2200/2064; F16H 3/66

(57) ABSTRACT

A transmission arrangement for a motor vehicle includes a first planetary gear set and a second planetary gear set. A first dog element is axially between the second and third dog elements and is rotationally fixed to the first ring gear. A first shift element shiftable to rotationally fix the first dog element to one or both of the first sun gear and the first planet gear carrier and a second shift element shiftable to rotationally fix the first shift element to one of the rotary elements of the second planetary gear set. A second dog element is rotationally fixed to the second sun gear and is rotationally fixable by the first shift element to one or both of the first sun gear and the first planet gear carrier. A third dog element is rotationally fixed to the second sun gear and connectable to the first ring gear by the second shift element.

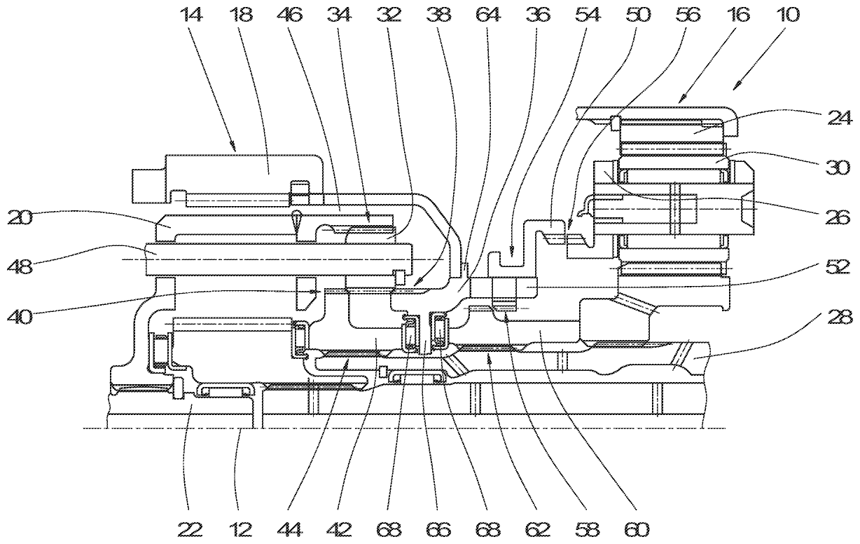

### CROSS-REFERENCE TO RELATED APPLICATION

The present application is related and has right of priority to German Patent Application No. 10 2019 205 755.1 filed on Apr. 23, 2019 and is a nationalization of PCT/EP2020/055628 filed in the European Patent Office on Mar. 4, 2020, both of which are incorporated by reference in their entirety for all purposes.

### FIELD OF THE INVENTION

The present application relates generally to a transmission arrangement for a motor vehicle and to a motor vehicle.

### BACKGROUND

Motor vehicles usually include a shiftable transmission, with which different gear stages take place during the transmission of torque from an engine to driven wheels of the motor vehicle.

In addition, modern motor vehicles also include a hybrid drive, with which a drive force is made available by multiple prime movers of various types. For example, a motor vehicle includes an electric machine as well as an internal combustion engine, by which the drive force is generated separately by either one, or also jointly by both. It is advantageous with regard to fuel consumption, environmental protection, and power when settable gears are made available for each prime mover separately and a common transmission is nevertheless provided for transmitting power and/or torque.

DE 10 2013 221 130 A1 describes, for example, a device for detachably connecting two components having at least one shaft. A shift element arranged on the shaft in a rotationally fixed manner is coupleable, in a rotationally fixed manner, to one of the components by a relative movement between the components and the shift element directed in the axial direction of the shaft. The shift element is therefore suitable not only for being able to establish and release a rotationally fixed connection between the shaft and a single component, but rather also to optionally rotationally fix the shaft to a first component or to a second component. The shift element therefore enables an additional shift condition, for which two shift elements were conventionally needed.

### SUMMARY OF THE INVENTION

Example aspects of the present application provide an improved transmission arrangement.

A first aspect relates to a transmission arrangement for a motor vehicle. The transmission arrangement includes at least a first planetary gear set having a first ring gear, a first sun gear, and a first planet gear carrier as rotary elements and a second planetary gear set having a second ring gear, a second sun gear, and a second planet gear carrier as rotary elements. One or several planet gear(s) is/are rotatably attached at the particular planet gear carriers. With respect to the two planetary gear sets and their rotary elements, a “first” and a “second” refers, with respect to the rotary elements, to their assignment to the first planetary gear set and the second planetary gear set, respectively. The second planetary gear set therefore does not need to have two ring gears. Instead, second planetary gear set has a single second ring gear. The particular planetary gear sets are also referred to as planetary transmissions. Preferably, the two planetary gear sets are coupled or coupleable to one another. With two planetary gear sets, a high number of different gear stages is provided, with the different gear stages also being referred to as “gears.” Simultaneously, planetary gear sets are highly compact and transmit high loads without damage. In addition, by providing two planetary gear sets, advantageously, the drive forces of two prime movers, in particular two different prime movers such as an electric machine and an internal combustion engine, are easily transmitted to particular driven wheels of the motor vehicle. In addition, different settable gears are made available for the electric machine and the internal combustion engine in order to optimally integrate these into the drive train.

The transmission arrangement also includes a first dog element, which is connected to the first ring gear at least in a rotationally fixed manner and which is rotationally fixable, by a first shift element, to at least one rotary element of the first planetary gear set other than the first ring gear and which is rotationally fixable to a rotary element of the second planetary gear set at least by a second shift element. “Rotationally fixed” means, in particular, that particular elements in a connection all rotate together or are all idle. Usually, such elements are therefore coaxially arranged. The first ring gear is a radially outermost rotary element of the first planetary gear set and, therefore, limits the accessibility to shift elements. In particular, the possible connection to the second planetary gear set greatly limits the accessibility of particular shift elements. These problems are mitigated due to the fact that the first dog element is connected to two shift elements. Particular shift elements are, for example, gear change sleeves.

Particular dog elements include, for example, an engagement means for establishing a detachable connection to the particular shift elements. One example engagement means is a toothing, which is brought into engagement with a corresponding toothing of the particular shift elements in order to rotationally fix these to one another. Preferably, an associated toothing is provided for each shift element, with which a connection is establishable. The shift elements are usually mounted, in particular, in an axially movable manner in order to establish and release the connection, which is also referred to as coupling and decoupling the connection. Preferably, in order to be moved, the shift elements are mechanically connected to an outer surface of a housing of the transmission arrangement, for example, by a shift rail or a selector fork. Particular toothings that are releasable by shifting are also referred to as selector teeth.

In addition, the transmission arrangement includes a second dog element, which is rotationally fixed to the second sun gear and which is rotationally fixable, by a shift element, in particular the first shift element, to at least one rotary element of the first planetary gear set other than the first ring gear. As a result, an additional shift condition is made available. In this way, another coupling of the second planetary gear set to the first planetary gear set is possible. The first shift element therefore optionally connects the second sun gear or the first ring gear to particular other rotary elements of the first planetary gear set. As a result, the transmission arrangement is particularly compact, while the accessibility for shifting movements is facilitated by the combination.

In addition, the transmission arrangement includes a third dog element, which is also rotationally fixed to the second sun gear and which is connectable to the first ring gear by a shift element, in particular the second shift element. The first dog element is mounted at the second dog element and the third dog element, axially therebetween. The mounting is therefore an axial mounting and establishes the axial position of the first dog element at the second dog element and the third dog element. Therefore, the first ring gear is simultaneously axially mounted. The axial mounting therefore takes place via the second planetary gear set, and so the axial mounting is not in the way, or is less in the way, of the accessibility of particular shift elements, in particular at the first planetary gear set. Preferably, the second dog element is arranged axially farther in the direction of the first planetary gear set than the third dog element.

The first dog element is rotatably mounted at the second dog element and the third dog element, and so these are not connected to each other in a rotationally fixed manner. For example, the first dog element is mounted at the second dog element and the third dog element by a needle bearing, which is an axial bearing in each case.

Due to the above-described transmission arrangement, particular shift elements are readily accessible in order to selectively move between two shift conditions for coupling with two different rotary elements or shafts. In particular, the second shift element is radially largely freely accessible from the outside and, in this way, is easily mechanically actuated. Particular shift elements are preferably displaceable between the above-described connection positions and a further position, in which a rotationally fixed connection is not established. This further position is therefore referred to as free-wheeling or as a decoupled position, wherein a rotationally fixed, detachable connection of two dog elements is not established by the appropriate shift element in this case. The transmission arrangement is also axially short. In addition, the first ring gear is mounted axially within components of the second sun gear or a central shaft of the second planetary gear set, as the result of which a compact nesting with few bearing points results.

Preferably, the second planetary gear set is arranged on the electric machine side and the first planetary gear set is arranged on the internal combustion engine side. Therefore, an input shaft at the second planetary gear set is connected to an output shaft of an electric machine and an input shaft at the first planetary gear set is connected to an output shaft of the internal combustion engine. As a result, the arrangement is compact and suited, in particular, for a front-mounted transverse installation. Preferably, the first sun gear is an input or drive shaft, which is connected, at least in a rotationally fixed manner, to the driven shaft of the internal combustion engine. The first ring gear is preferably an output shaft of the transmission, which is connected, in particular, via an intermediate shaft and/or a differential to driven wheels of the motor vehicle. Preferably, the second sun gear is connected, at least in a rotationally fixed manner, to the drive output of the electric machine or a shaft driven by the electric machine, in particular to its rotor.

In one further embodiment of the transmission arrangement, it is provided that the first dog element and the second dog element are optionally connectable to the first planet gear carrier by the first shift element. In this way, the second sun gear is connected to the first planet gear carrier or, alternatively, in another shift position, the first ring gear is connected to the first planet gear carrier. Advantageous shift positions result in this way. In addition, the first shift element therefore enables two desired, alternative, rotationally fixed connections in a manner that saves installation space.

In one further embodiment of the transmission arrangement, it is provided that the third dog element and the second planet gear carrier are optionally connectable to the first dog element by the second shift element. By the second shift element, therefore, in one shift position, the first ring gear is rotationally fixed to the second sun gear and, in a further shift position, the first ring gear is rotationally fixed to an appropriate dog element of the second planet gear carrier. Advantageous shift positions also result in this way. In addition, the second shift element therefore enables two desired, alternative, rotationally fixed connections in a manner that saves installation space.

In one further embodiment of the transmission arrangement, it is provided that the second shift element is axially movably mounted at the first dog element, in particular by particular finger elements in corresponding recesses. For this purpose, the second shift element is a sleeve. Particular finger elements are formed, in particular, at an end surface. The same applies for the corresponding recesses. Due to an axial guidance of this type, the second shift element is also accessible radially from the outside for its displacement. In addition, a guidance of this type saves installation space and does not get in the way of the arrangement of other parts. In this way, the transmission arrangement is compact and the second shift element is nevertheless easily accessible from the outside for a mechanical actuation.

In one further embodiment of the transmission arrangement, it is provided that the first shift element is arranged within a cavity defined by the first ring gear, in particular within a cavity defined by a first ring gear carrier. The first ring gear includes a first ring gear carrier. Similarly, the second ring gear includes a second ring gear carrier. The ring gear carrier forms one piece with the rest of the ring gear or also as multiple pieces, wherein the ring gear carrier is preferably rotationally fixed to the rest of the ring gear. The first shift element is then moved axially for shifting, for example, simply via an axial shift rail, which extends through the first ring gear. In addition, there is frequently sufficient space in the ring gear for also providing a shift element therein. In this way, the transmission arrangement is particularly compact. The first shift element therefore has an axial position that is located within the axial extension of the first ring gear. Preferably, the first shift element also has a radial extension that is shorter than that of the first ring gear.

In one further embodiment of the transmission arrangement, it is provided that the second dog element is arranged essentially within the cavity defined by the first ring gear, in particular by the first ring gear carrier. In particular, the second dog element has a radial overlap with the cavity. This also enables the nesting of the transmission arrangement and the compactness to be increased. In addition, the first dog element must therefore project to a lesser extent or not at all beyond the first ring gear and is nevertheless axially mounted, as described, at the central shaft of the second planetary gear set. The second dog element therefore has an axial position that is located within the axial extension of the first ring gear. Preferably, the second dog element also has a radial extension that is shorter than that of the first ring gear. In particular, the arrangement of the second dog element therefore corresponds to that of the first shift element, and so the displacement distance and the size of these particular parts are small.

In one further embodiment of the transmission arrangement, it is provided that the third dog element is arranged outside the cavity defined by the first ring gear, in particular by the first ring gear carrier. As a result, the first dog element is advantageously mounted axially close to the axial end of the first ring gear, as the result of which the second shift element is easily accessible from the outside for a displacement, while the transmission arrangement is axially very short. The third dog element is therefore arranged outside an axial area of the cavity of the first ring gear.

In one further embodiment of the transmission arrangement, it is provided that the second dog element and/or the third dog element are/is axially movably mounted at the second sun gear, in particular a second sun gear shaft. This yields advantages with regard to manufacturing tolerances and load bearing in the transmission arrangement. In particular, in this way, an overdetermined mounting is avoided due to the possible coupling of the two planetary gear sets to one another. The second dog element and/or the third dog element is rotationally fixed to the second sun gear, for example, by particular corresponding driving toothings. The first sun gear includes a first sun gear shaft. Similarly, the second sun gear includes a second sun gear shaft. The sun gear shaft forms one piece with the rest of the sun gear or also as multiple pieces, wherein the sun gear shaft is preferably rotationally fixed to the rest of the sun gear.

In one further embodiment of the transmission arrangement, it is provided that the first dog element is axially movably connected to the first ring gear, wherein the axial mobility is limited, at least on one side, by a stop. The stop is formed, for example, by particular circumferential collars and/or shoulders of the first dog element and/or of the first ring gear. This also enables an overdetermined mounting to be avoided, while, simultaneously, axial loads acting upon the first ring gear are supported at least in one direction. Preferably, the stop limits an axial mobility in the direction of the second planetary gear set. As a result, axial loads acting upon the first ring gear in this direction are guided via the first dog element to the second planetary gear set, which advantageously supports these loads.

In one further embodiment of the transmission arrangement, it is provided that the two planetary gear sets are arranged coaxially next to one another, in particular directly adjacent and/or at least partially radially nested. As a result, the transmission arrangement is particularly compact and bears high loads. In particular, a radial overlap of particular rotary elements of the two different planetary gear sets is possible. The first planetary gear set has, at least partially axially, an installation space area that is the same for the second planetary gear set, wherein particular parts in this area are then radially offset with respect to one another. As a result, the transmission arrangement is axially particularly short.

In one further embodiment of the transmission arrangement, it is provided that the first dog element is an essentially annular body. An annular body is advantageously arranged radially outside and/or radially within the particular rotary elements of the transmission arrangement so that the transmission arrangement is particularly compact. In particular, the annular body is arranged at least partially radially between the first ring gear and a portion of the second sun gear or components mounted on its shaft.

In one further embodiment of the transmission arrangement, it is provided that an inner passage opening of the first dog element has a larger diameter, at least in some areas, than the second dog element, the third dog element, the second sun gear shaft, and/or the second sun gear. Preferably, a narrowest diameter is greater than a portion of the sun gear, or a part rotationally fixed thereto, arranged in the same axial area. Preferably, at least particular facing and adjacent areas of the walls of the first dog element forming the passage opening have a larger diameter than the second and/or third dog elements. In this way, the transmission arrangement is particularly extremely nested and compact.

In one further embodiment of the transmission arrangement, it is provided that the first dog element has, at least in some areas, a radial overlap with the second dog element, the third dog element, the second sun gear shaft, and/or the second sun gear. In particular, the first dog element is arranged radially outward around areas of the second dog element, the third dog element, and/or the second sun gear. In this way, the transmission arrangement requires a particularly short axial installation space and the first dog element is nevertheless accessible radially from the outside.

In one further embodiment of the transmission arrangement, it is provided that the annular body has a radially inwardly projecting, at least partially circumferential ridge, which has, at least partially, an axial overlap with the second dog element and the third dog element and with which the first dog element is mounted at the second dog element and the third dog element. The ridge therefore protrudes radially inward to such an extent that it extends up to the second dog element and the third dog element for the axial mounting. The ridge is axially substantially shorter in comparison to the rest of the annular body. Therefore, the second dog element and the third dog element are arranged axially closer to one another. In addition, the first dog element is arranged with its main portion radially outside the second dog element and the third dog element. Therefore, the second dog element and the third dog element are also nested radially with respect to one another. The transmission arrangement is therefore particularly axially compact and the accessibility of the second shift element from the outside is still ensured.

A second aspect relates to a motor vehicle including a transmission arrangement according to the first aspect. The features and advantages resulting from the transmission arrangement according to the first aspect are to be derived from the descriptions of the first aspect, wherein embodiments of the first aspect are to be considered to be embodiments of the second aspect, and vice versa.

The motor vehicle preferably includes an electric machine and an internal combustion engine, which are both connected to particular driven wheels by the transmission arrangement in order to transmit a drive force.

Further features result from the claims, the exemplary embodiment, and on the basis of the drawing. The features and combinations of features mentioned above in the description as well as the features and combinations of features mentioned in the following in the exemplary embodiments are usable not only in the particular described combination, but rather also in other combinations, without departing from the scope.

### BRIEF DESCRIPTION OF THE DRAWING

The FIGURE illustrates a partial, schematic sectional view of a transmission arrangement for a motor vehicle.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

The FIGURE shows a partial, schematic section view of a transmission arrangement 10 of a motor vehicle. The transmission arrangement 10 has a central axis 12, to which all essential elements of the transmission arrangement 10 are coaxial and about which all essential elements of the transmission arrangement 10 are rotationally symmetrical. The central axis 12 defines an axial direction, with respect to which a radial direction is orthogonal.

The transmission arrangement 10 includes a first planetary gear set 14 arranged on the left in the FIGURE and a second planetary gear set 16 arranged on the right in the FIGURE. The two planetary gear sets 14, 16 are therefore arranged essentially axially adjacent, next to one another. Via the second planetary gear set 16, drive forces of an electric machine (not shown) connected thereto are guided into a drive train of the motor vehicle. Via the first planetary gear set 14, by comparison, drive forces of an internal combustion engine (not shown) connected thereto are introduced into the drive train. The internal combustion engine and the electric machine are arranged axially to the left and the right of the transmission arrangement 10, respectively, whereby a particular suitability for a front-mounted transverse installation is given.

The first planetary gear set 14 includes a first ring gear carrier 18, which is also referred to simply as a first ring gear 18, a first planet carrier 20, and a first sun gear 22, which are considered to be rotary elements of the first planetary gear set 14. The second planetary gear set 16 includes, correspondingly, a second ring gear 24, a second planet gear carrier 26, and a second sun gear 28, which are considered to be rotary elements of the second planetary gear set 16. The particular rotary elements of each planetary gear set 14, 16 are rotationally fixed differently to one another and to particular rotary elements of the other planetary gear set in order to provide different gear stages and gears for the electric machine and the internal combustion engine separately in order to introduce their drive forces at particular driven wheels.

In the FIGURE, a planet gear 30 is shown, which is rotatably mounted at the second planet gear carrier 26. Each planet gear carrier 20, 26 includes multiple planet gears distributed over the circumference. Each rotary element includes one or multiple dog element(s) and/or shaft(s) permanently rotationally fixed thereto. These dog elements and/or shafts are therefore also considered to be part of these rotary elements.

In the present case, the electric machine is connected, with its rotor, to the second sun gear 28. The internal combustion engine is connected, with its output shaft, to the first sun gear 22. The first ring gear 18 functions, in the transmission arrangement, as a common output shaft for transmitting the drive force and a driving torque.

The transmission arrangement 10 includes at least a first shift element 32, which is permanently rotationally fixed to the first planet gear carrier 20 at the dog toothing 34. In addition, a first dog element 36, which has a radially upward pointing dog toothing 38 on the left side, is permanently rotationally fixed to the first ring gear 18. By axially moving or displacing the first shift element 32 to the right, the first shift element 32 is rotationally fixed to the first dog element 36 with a corresponding toothing, whereby a rotationally fixed connection between the first ring gear 18 and the first planet carrier 20 and, thereby, an appropriate ratio and an appropriate gear is selected. The shift element 32 is also moved axially to the left, whereby an engagement at a dog toothing 40 of a second dog element 42 is established. The second dog element 42 is rotationally fixed via a driving toothing 44 to the second sun gear 28, although it is attached in an axially easily moveable manner in order to avoid an overdetermination of particular mountings of the transmission arrangement 10 and/or its components by redundant features. Therefore, the first planet gear carrier 20 is rotationally fixable to the second sun gear 28. In addition, when the first shift element 32 is moved into the position shown in the FIGURE, it does not couple the first planet gear carrier 20 to a further rotary element and which is also referred to as free-wheeling.

The first shift element 32 therefore already enables three shift conditions, as the result of which the transmission is compact despite having a high number of different gears. The first shift element 32 is completely accommodated in a cavity 46 formed by the first ring gear 18 and its first dog element 36, as the result of which the transmission arrangement 10 is particularly compact and nested. The first shift element 32 is moved from the outside by a shift rail 48, which is also axially guided through the cavity 46. As a result, an outer accessibility in combination with a compact design is ensured.

In addition, the transmission arrangement 10 includes a second shift element 50, which is, in the present case, a slidable sleeve. The second shift element 50 is axially guided with particular recesses at finger elements 52, wherein the finger elements 52 are formed at an end surface of the first dog element 36. As a result, the second shift element 50 remains accessible radially from the outside for displacement and/or movement, without a separate mounting being necessary. This also enables the transmission arrangement to be particularly compact. The second shift element 50 has, for example, in the present case, a groove 54 that is circumferential on the outer side, into which a selector fork or a shift rail engages radially from the outside.

In the FIGURE, a position of the second shift element 50 is shown, in which the second shift element 50 is not in engagement with a further rotary element. A free-wheeling position is therefore shown. If the second shift element 50 according to the FIGURE is displaced axially toward the right, an outer dog toothing 56 comes into engagement with a corresponding toothing of the second planet gear carrier 26. As a result, the first ring gear 18 is rotationally fixable to the second planet carrier 26. If the second shift element 50 is moved axially toward the left, an inner dog toothing 58 comes into engagement with a corresponding toothing of a third dog element 60. The third dog element 60—similarly to the second dog element 42—is connected to the second sun gear 28 by a driving toothing 62 in a permanently rotationally fixed but axially easily displaceable manner. Correspondingly, in a shift position of this type, the ring gear 18 is rotationally fixed to the second sun gear 28 by the second shift element 50. The second shift element 50 therefore also enables three shift conditions, wherein the second shift element 50 is easily accessible from the outside for displacement. This also enables the transmission to be compact and simple despite having a high number of different gears.

In the present case, the first dog element 36 is axially supported only on one side, on the left, against the first ring gear 18 by a collar 64. As a result, an overdetermined mounting is avoided. Alternatively, the first dog element 36 is connected to the first ring gear 18 not only in a rotationally fixed manner but also in an axially fixed manner.

The first dog element 36 also includes a radially inwardly projecting, circumferential ridge 66. This ridge 66 projects radially inward up to mutually facing end surfaces of the second dog element 42 and of the third dog element 60. By this ridge 66, the first dog element 36 is mounted axially between the second dog element 42 and the third dog element 60. In the present case, an axial needle bearing 68 is provided at each end surface for this purpose.

In this way, the first dog element 36 and, thereby, also at least one side of the first ring gear 18 are integrated into an axial mounting and an axial power flow of the transmission arrangement 10. In particular, these are then axially supported at the second sun gear 28. The second sun gear 28 is axially mounted at a housing wall, if necessary indirectly via the second planet gear carrier 26 and/or the second ring gear 24. An axial load from both planetary gear sets 14, 16 is also easily compensated for with respect to one another in this way, and so the transmission arrangement 10 remains largely free from axial loads toward the outside.

In the present case, the first dog element 36 is also utilized for limiting the cavity 46 of the ring gear 18. In addition, the first dog element 36 at least partially occupies the same axial installation space as the second dog element 42 and the third dog element 60, which is achieved due to the thin radial ridge 66. This enables a radial offset of the remainder of the first dog element 36 in combination with an axial mounting. As a result, in addition, an arrangement is achieved for the second shift element 50, in which the second shift element 50 is accessible radially from the outside in order to be moved. Overall, in this way, an extreme nesting and, thereby, in particular, an axially compact design is achieved, in which the two shift elements 32, 50 are nevertheless moved with little complexity using mechanical means, such as shift rails or selector forks.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

10 transmission arrangement

12 central axis

14 first planetary gear set

16 second planetary gear set

18 first ring gear

20 first planet gear carrier

22 first sun gear

24 second ring gear

26 second planet gear carrier

28 second sun gear

30 planet gear

32 first shift element

34 dog toothing

36 first dog element

38 dog toothing

40 dog toothing

42 second dog element

44 driving toothing

46 cavity

48 shift rail

50 second shift element

52 finger elements

54 groove

56 dog toothing

58 dog toothing

60 third dog element

62 driving toothing

64 collar

66 ridge

68 axial needle bearing

1-15. (canceled)

16. A transmission arrangement (10) for a motor vehicle, comprising:
a first planetary gear set (14) having rotary elements including a first ring gear (18), a first sun gear (22), and a first planet gear carrier (20);
a second planetary gear set (16) having rotary elements including a second ring gear (24), a second sun gear (28), and a second planet gear carrier (26);
a first dog element (36) rotationally fixed to the first ring gear (18);
a first shift element (32) shiftable to rotationally fix the first dog element (36) to one or both of the first sun gear (22) and the first planet gear carrier (20);
a second shift element (50) shiftable to rotationally fix the first shift element (32) to one of the rotary elements of the second planetary gear set (16);
a second dog element (42) rotationally fixed to the second sun gear (28) and rotationally fixable by the first shift element (32) to one or both of the first sun gear (22) and the first planet gear carrier (20); and
a third dog element (60) rotationally fixed to the second sun gear (28) and connectable to the first ring gear (18) by the second shift element (50),
wherein the first dog element (36) is axially between the second dog element (42) and the third dog element (60).

17. The transmission arrangement (10) of claim 16, wherein the first dog element (36) and the second dog element (42) are alternately connectable to the first planet gear carrier (20) by the first shift element (32).

18. The transmission arrangement (10) of claim 16, wherein the third dog element (60) and the second planet gear carrier (26) are alternately connectable to the first dog element (36) by the second shift element (50).

19. The transmission arrangement (10) of claim 16, wherein the second shift element (50) is axially movably mounted at recesses of particular finger elements (52) of the first dog element (36).

20. The transmission arrangement (10) of claim 16, wherein the first shift element (32) is arranged within a cavity (46) defined by the first ring gear (18).

21. The transmission arrangement (10) of claim 16, wherein the second dog element (42) is arranged at least partially within a cavity (46) defined by the first ring gear (18).

22. The transmission arrangement (10) of claim 16, wherein the third dog element (60) is arranged outside a cavity (46) defined by the first ring gear (18).

23. The transmission arrangement (10) of claim 16, wherein one or both of the second dog element (42) and the third dog element (60) is axially movably mounted on a shaft of the second sun gear (28).

24. The transmission arrangement (10) of claim 16, wherein the first dog element (36) is axially movably connected to the first ring gear (18), wherein the first dog element (36) has a collar (64) against which the first ring gear (18) at least selectively abuts.

25. The transmission arrangement (10) of claim 16, wherein the first and second planetary gear sets (14, 16) are coaxial, and
wherein the first and second planetary gear sets (14, 16) are one or both of directly adjacent and at least partially radially nested.

26. The transmission arrangement (10) of claim 16, wherein the first dog element (36) is an annular body.

27. The transmission arrangement (10) of claim 26, wherein an inner passage opening of the first dog element (36) has a larger diameter than at least part of one or more of the second dog element (42), the third dog element (60), the second sun gear (28), and a shaft of the second sun gear (28).

28. The transmission arrangement (10) of claim 27, wherein the first dog element (36) at least partially radially overlaps with one or more of the second dog element (42), the third dog element (60), the second sun gear (28), and the shaft of the second sun gear (28).

29. The transmission arrangement (10) of claim 26, wherein the annular body has a radially inwardly projecting ridge (66) extending at least partially circumferentially, the ridge (66) at least partially axially overlapping with the second dog element (42) and the third dog element (60), the ridge (66) mounting the first dog element (36) at the second dog element (42) and the third dog element (60).

30. A motor vehicle, comprising the transmission arrangement (10) of claim 16.
